(19) United States
(12) Patent Application Publication
(10) Pub. No.: US 2016/0268669 A1
(43) Pub. Date: Sep. 15, 2016

(54) ARTICULATING MARINE ANTENNA MOUNT WITH SELF-LOCKING WORM DRIVE

(71) Applicant: Eastern Metal Supply Inc., Lake Worth, FL (US)

(72) Inventor: Scott Wilcox, Dania Beach, FL (US)

(21) Appl. No.: 14/926,944

(22) Filed: Oct. 29, 2015

Related U.S. Application Data
(60) Provisional application No. 62/073,886, filed on Oct. 31, 2014.

(51) Int. Cl. H01Q 1/12; H01Q 1/34; F16M 11/18

(52) U.S. Cl. CPC H01Q 1/125; F16M 11/18; H01Q 1/34; F16M 2200/024

(57) ABSTRACT

An antenna mount apparatus for use on a marine vessel for supporting and angularly positioning an antenna is provided. The apparatus includes: a housing configured to mount the apparatus to a support structure; a bi-directionally rotatable driver mounted on the housing; a worm configured to be rotatably driven by the driver about a first axis; a rotatable member having gear teeth at least partially around a periphery of the rotatable member, and configured to be driven about a second axis perpendicular to the first axis in response to rotation of the worm; and a rotatable antenna support member mounted on the rotatable member configured to support an antenna and to rotate in response to the rotatable member, the antenna support member being rotatable between a substantially horizontal position and a substantially vertical position.

### CROSS REFERENCE TO RELATED APPLICATIONS

The instant application claims priority to U.S. Provisional Application No. 62/073886 entitled ARTICULATING MARINE ANTENNA MOUNT WITH SELF-LOCKING WORM DRIVE filed on Oct. 31, 2014, which is incorporated by reference herein in its entirety.

### FIELD OF THE INVENTION

The invention relates to the field of wireless marine communications. More particularly, the invention relates to an articulating marine antenna mount for supporting, and selectively positioning and repositioning a marine antenna on a marine vessel and which includes a self-locking worm drive and which may allow an antenna to be selectively positioned substantially infinitely variably, at virtually any position within an arc of travel extending over a desired angular range.

### BACKGROUND OF THE INVENTION

Marine antennas are typically mounted to a marine vessel to enable transmission and/or reception of voice, data, video, audio, weather information, navigational information, GPS or other position information, radar signals, emergency beacon signals and/or other wireless electromagnetic signals. Marine antennas are typically mounted at a position and orientation such that their antenna element extends to at least a height sufficient to permit such signals to be transmitted over, and/or received from, an adequately long distance range from the vessel and with as little electromagnetic obstruction from other vessel structures as practicable. Such mounting is also desirable for reducing susceptibility to electrical noise or electromagnetic interference from other electrical or electronic equipment of the vessel.

Particularly when a marine vessel is near a dock, in a harbor or anywhere other than relatively open water, a marine antenna deployed in such an upwardly extended position can present difficulties and hazards, even if the vessel is stationary but particularly while the vessel is underway. The height of the antenna reduces the overall clearance to overhead obstacles, such as bridges overhanging trees, suspended cables or other overhead obstacles. Accordingly, it is important to have the capability of bringing the antenna to a lowered orientation at which the highest point on the antenna is at a sufficiently low elevation as not to restrict the ability of the vessel to pass safely beneath bridges or other overhead obstacles.

It is also desirable to be able to position, or reposition, a marine antenna quickly, safely and without undue effort. The ability to do so is important not only to being able to lower the antenna to prevent the antenna from impacting overhead obstacles but also to being able to bring the antenna to an operating position rapidity, such as for purposes of deploying the antenna for communication or signaling in an emergency. It is also desirable that positioning or re-positioning the antenna from one orientation to another should not require undue time, effort or safety risk.

For safety and ease of use, it is also desirable that the positioning of the antenna can be performed by a person from a safe and convenient location on the marine vessel. For example, it is preferable that stowing, deploying or repositioning not require leaning over the side of the vessel, climbing or reaching precariously, as doing so might present a risk of bodily injury.

Unexpected or undesired detachment, falling or other loss of control over the position of a marine antenna can give rise to substantial safety hazards, not the least of which is the potential for loss, interruption or degradation of the antenna to transmit and/or receive signals. This could result in inability of the vessel to carry out important communications, navigation and/or signaling functions which rely on the functionality of the antenna. Particularly when a vessel is underway or under rough weather conditions, an antenna may experience a number of significant external forces. The movement of the vessel and/or any prevailing wind act to exert a wind drag force on the antenna. It is desirable that a marine antenna mount reliably maintain a desired position of the antenna so that the antenna element does not swing about, drop or otherwise change position unexpectedly, thus and become damaged and/or cause injury to crew, passengers or other persons and/or cause damage to the vessel and/or other property. For similar reasons, the position of the antenna should be maintained under positive control while the antenna is in the process of being positioned or repositioned.

FIG. 1 shows a marine antenna mount 10 of a type known in the prior art. Mount 10 has a mounting base 12 provided with a plurality of holes 13 by way of which mount 10 can be secured to a structure of a marine vessel using screws or other fasteners. Projecting from mounting base 12 is a body terminating in an antenna support member 14 which includes a cylindrical stub 16 having external threads by way of which an antenna (not shown) can be removably secured to mount 10. To permit the stub 16, and thus the antenna, to be angularly positioned and/or re-positioned relative to mounting base 12, mount 10 includes a lower pivotable joint 18 and an upper pivotable joint 20.

Lower pivotable joint 18 includes a first pair of jaws 27 and 31 which are attached to one another by a bolt 35 which passes through jaws 27 and 31 along a lower axis 38 and is secured by a nut 33. Jaws 27 and 31 have interlocking teeth disposed at discretely spaced angular intervals. When nut 33 and bolt 35 are sufficiently loosened, the interlocking teeth of jaws 27 and 31 can be separated sufficiently to disengage from interlocking with one another and thereby permit a user to angularly position or re-position the antenna relative to lower axis 38 by grasping the mount 10 and/or the antenna, tilting them to a desired angular position relative to lower axis 38 and subsequently re-tightening nut 33 and bolt 35 using a pair of wrenches or other suitable hand tools to secure the antenna at the desired angular location.

Upper pivotable joint 20 includes a second pair of jaws 40 and 41 which are attached to one another by a nut 43 and a bolt 44 which passes through jaws 40 and 41 along an upper axis 46. Like jaws lower jaws 27 and 31, upper jaws 40 and 41 also have interlocking teeth disposed at discretely spaced angular intervals. Upper pivotable joint 20 includes a lever 48, a central end of which is mounted on bolt 44 between the head of bolt 44 and an external face 50 of upper jaw 40. The external face 50 of upper jaw 40 includes a cam ramp 52 which is engageable with a cam follower 54 which extends radially outward from the central end of lever 48. When lever 48 is rotated by a user in one angular direction about upper axis 46, the cam follower 54 moves along the cam ramp 52 in a direction which permits the interlocking teeth of upper jaws 40 and 41 to be separated sufficiently to disengage from interlocking with one another and thereby permit a user to angularly position or re-position the antenna relative to upper axis 46 by grasping the antenna support member 14 and/or the antenna, and tilting them to a desired angular position relative to upper axis 46. To secure the antenna, the user then must move the lever in an opposite angular direction about upper axis 46 to cause the cam follower 54 to move along the cam ramp 52 in a direction which forces the interlocking teeth of upper jaws 40 and 41 into interlocking engagement. Applicant has recognized that prior art marine antenna mounts such as mount 10 suffer from a number of significant drawbacks and deficiencies.

The necessity of use of using tools in order to angularly position or reposition a marine antenna is highly undesirable. Tools can be lost, misplaced or otherwise not readily available when needed. This may be particularly problematic under circumstances where it might be necessary to lower an antenna quickly, such as to prevent it from being damaged in a storm or avoid impact with an overhead obstacle or when it may be necessary to raise the antenna to a deployed position in order to be able to send or receive communications or other signals in an emergency.

The use of jaws with interlocking teeth such as those relied upon by certain prior art antenna mounts, such as mount 10 described above, may also impose a need to compromise between mechanical strength the ability to position the antenna accurately. Positionability is limited to angular positions corresponding precisely to the discrete and mutually angularly spaced mating positions of the teeth which fix the antenna at one of those positions. Securing the antenna at intermediate angular positions anywhere between such mating positions cannot be achieved. This disadvantage can be ameliorated somewhat, but not completely eliminated, by decreasing the size and increasing the number of teeth but smaller teeth are not as strong as larger ones, all other things being equal.

When an antenna is mounted to a structure of the marine vessel which is overhead of a user, such as on the roof of a pilot house or on top of a T-top, the user may have difficulty reaching and/or manipulating a lever such as lever 48, without climbing atop the structure or otherwise assuming a potentially awkward, unsafe or inconvenient position.

Prior art antenna mounts such as mount 10 described above also leave critical mating surfaces, such as the mating surfaces of cam ramp 52 and cam follower 54, exposed to the elements where they may be readily subject to impact damage, contamination, corrosion or other deleterious influences. Such exposure also makes it difficult to maintain suitable lubrication of such mating surfaces.

Because cam ramp 52 and cam follower 54 mate with one another over a relatively small region of contact when fully tightened, prior art antenna mounts such as the mount 10 described above, may also be susceptible to loosing under vibration and/or thermal expansion unless over-tightened to such a degree that loosening without using a tool may be difficult or impossible.

### SUMMARY OF THE INVENTION

An articulating marine antenna mount for supporting, positioning and repositioning a marine antenna on a marine vessel and includes a self-locking worm drive which is supplied with motive power from a driving device.

According to an embodiment of the invention, an antenna mount apparatus for use on a marine vessel for supporting and angularly positioning an antenna is provided. The apparatus includes: a housing configured to mount the apparatus to a support structure; a bi-directionally rotatable driver mounted on the housing; a worm configured to be rotatably driven by the driver about a first axis; a rotatable member having gear teeth at least partially around a periphery of the rotatable member, and configured to be driven about a second axis perpendicular to the first axis in response to rotation of the worm; and a rotatable antenna support member mounted on the rotatable member configured to support an antenna and to rotate in response to the rotatable member, the antenna support member being rotatable between a substantially horizontal position and a substantially vertical position.

The above embodiment may have various optional features. The apparatus may be self-locking, whereby the worm prevents rotation of the antenna support in response to the external forces applied to the antenna support, other than from actuation of the a bi-directionally rotatable driver. The rotatable driver may include a manually powered hand crank, wherein the hand crank is moveable between two vertical positions, the first position being higher than the second position, wherein in the first position the crank is coupled to the worm such that rotation of the crank drives the worm, and wherein in the second position the crank is decoupled from the worm. Gravity or a spring may bias the hand crank toward the second position. The apparatus may prevent the crank from rotating in the second position. The driver comprises an electric motor. The apparatus may include electrical relays configured along a path of the worm, the apparatus being configured to trip one of the relays and disable the motor if the motor over rotates the antenna support member. The apparatus may include a threaded block mounted on the worm, a rack gear mounted on the block, the rack gear engages with the rotating gear, wherein rotation of the worm moves the block and rack gear to thereby rotate the rotating gear.

According to another embodiment of the invention, an antenna mount apparatus for use on a marine vessel for supporting and angularly positioning an antenna is provided. The apparatus includes: a housing configured to mount the apparatus to a support structure; hand crank mounted on the housing; a worm configured to be rotatably driven by the crank about a first axis; a worm gear coupled to and configured to be driven about a second axis perpendicular to the first axis in response to rotation of the worm; and a rotatable antenna support member having lateral arms mounted on the worm gear, configured to support an antenna and to rotate in response to the rotatable member, the antenna support member being rotatable between a substantially horizontal retracted position and a substantially vertical deployed position; wherein the apparatus is self-locking, whereby the worm prevents rotation of the worm gear as a result of external forces applied to the antenna support other than from actuation of the crank.

The above embodiment may have various optional features. The hand crank may be moveable between first and second vertical positions, the first position being higher than the second position, wherein when in the first position the crank is coupled to the worm such that rotation of the crank drives the worm, and wherein when in the second position the crank is decoupled from the worm. Gravity or a spring may bias the hand crank toward the second position. The apparatus may prevent the crank from rotating in the second position. The apparatus may include: a plate with at least one groove mounted to the housing and a shaft coupled to the crank and having a pin, wherein in the first position of the crank the pin is within one of the grooves such that engagement of the pin with the one of the grooves prevents rotation of the crank; and wherein in the second positon of the crank the pin is outside of the at least one groove such that the at least one groove does not interfere with the rotation of the crank. The shaft may extend through the plate.

These and other objects and advantages of disclosed embodiments will become readily apparent to a person of ordinary skill in the art upon review of the following detailed description together with review of the appended drawings wherein like reference numerals are used to denote like items and wherein the various Figs. of the drawings are as briefly described below

### BRIEF DESCRIPTION OF THE DRAWINGS

FIG. 1 is a perspective view of a prior art antenna mount;

FIG. 2 is a perspective view of an embodiment of antenna mount apparatus of having a manually operable hand crank;

FIG. 3 is a partially schematic, partially cross-sectional view, of another embodiment of antenna taken along line 3-3 of FIG. 2, where the embodiment of FIG. 3 is the same as the embodiment of FIG. 2 except that the embodiment of FIG. 3 has an electric motor rather than a manually operable hand crank;

FIG. 4 is a partial cross-sectional view of the embodiment of FIG. 2;

FIG. 5A is an enlarged perspective view of an upper side of a cap shown in FIG. 4;

FIG. 5B is an enlarged perspective view of a lower side of the cap shown in FIG. 4;

FIG. 6 is a partial, perspective view of another embodiment of antenna mount apparatus;

FIG. 7 is an exploded view of another embodiment of antenna mount apparatus;

FIG. 8 is a partial cross-sectional view of another embodiment of the invention.

FIG. 9 is a partial cross-sectional view of another embodiment of the invention.

FIGS. 10A and 10B are perspective and side views of another embodiment of the invention.

FIGS. 11A-11B are partial cross section side views of the embodiment of FIG. 10A.

FIG. 11C is an exploded view of the embodiment of FIG. 11A.

FIG. 12 is a clock diagram of circuit elements for the embodiment of FIG. 11A.

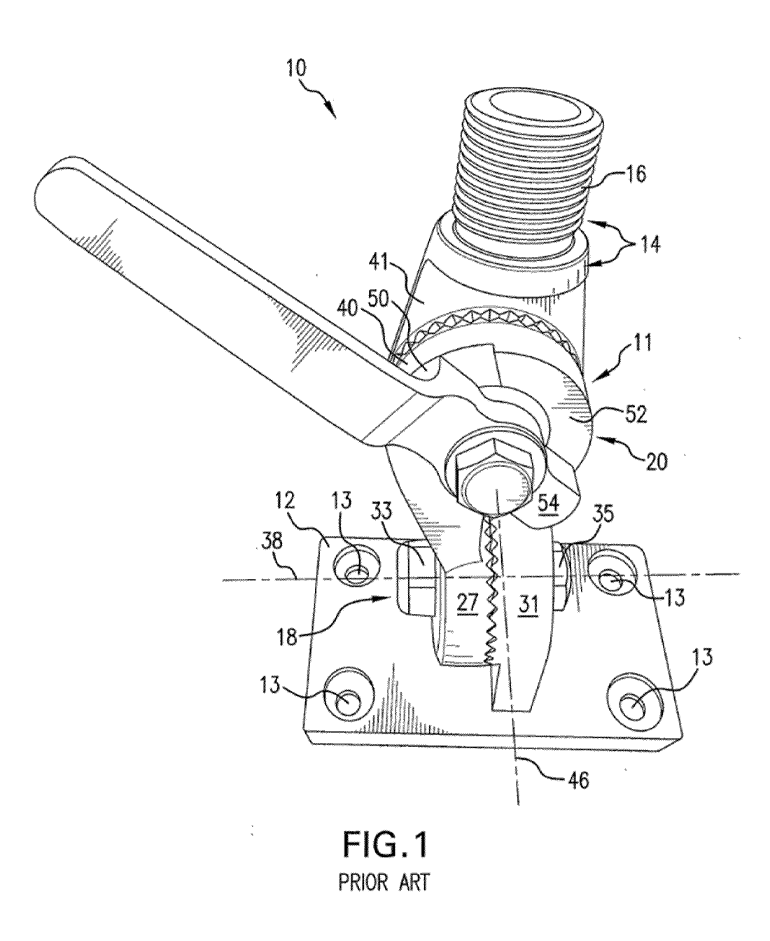

### DETAILED DESCRIPTION OF PREFERRED EMBODIMENTS

In the following description, various embodiments will be illustrated by way of example and not by way of limitation in the Figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Several definitions that apply throughout this disclosure will now be presented. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” when utilized, means “including, but not necessarily limited to”; it specifically indicates open-ended inclusion or membership in the so-described combination, group, series and the like. The term “a” means “one or more” unless the context clearly indicates a single element. The term “coupled” as between components means directly engaged or indirectly engaged through intervening elements such that movement of one component influences movement of the coupled component.

As used herein, the term “front”, “rear”, “left,” “right,” “top” and “bottom” or other terms of direction, orientation, and/or relative position are used for explanation and convenience to refer to certain features of this disclosure. However, these terms are not absolute, and should not be construed as limiting this disclosure.

Shapes as described herein are not considered absolute. As is known in the art, surfaces often have waves, protrusions, holes, recess, etc. to provide rigidity, strength and functionality. All recitations of shape herein are to be considered modified by “substantially” regardless of whether expressly stated in the disclosure or claims, and specifically accounts for variations in the art as noted above.

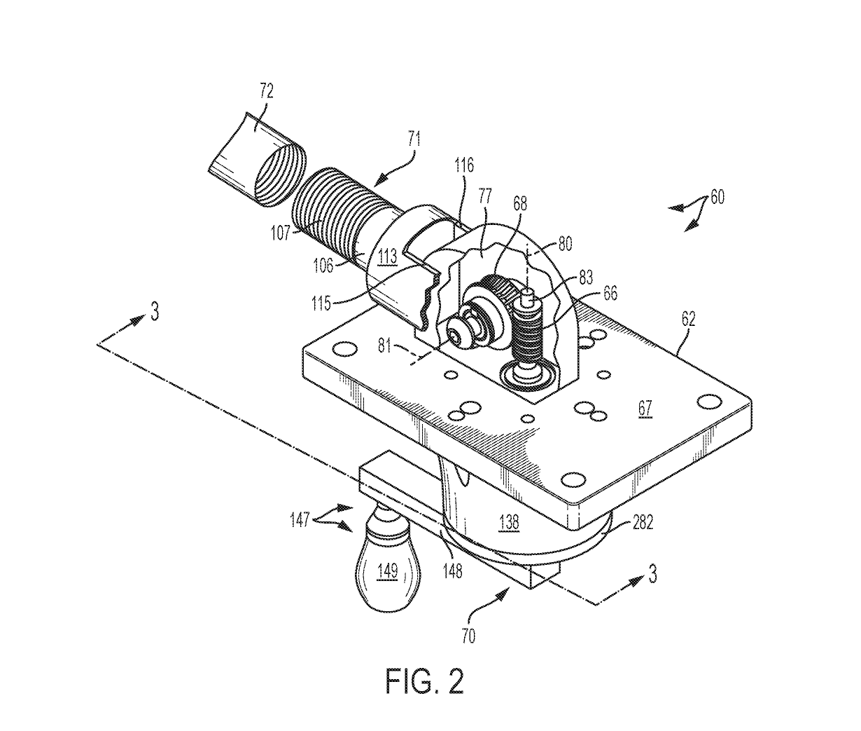

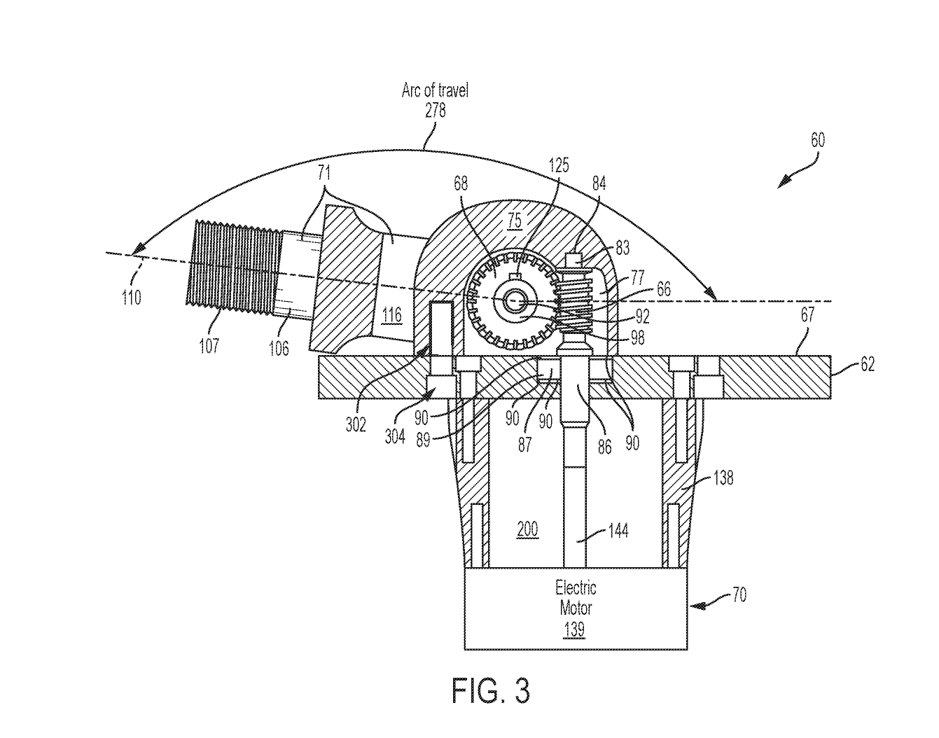

FIGS. 2 and 3 illustrate respectively a first embodiment and a second embodiment of an antenna mount apparatus 60. Each includes: a base 62 for mounting the apparatus 60 to a structure of the marine vessel; a worm drive 64 that may be self-locking and having a worm 66, and a gear 68 driven by the worm 66; a bi-directional rotatable driving device 70 for driving the worm; and an antenna support member 71 for supporting an antenna 72. However, in the embodiment of FIG. 2 the rotatable driving device 70 features a manual hand crank whereas in the embodiment of FIG. 3, the rotatable driving device 70 comprises an electric motor.

Gear 68 may be any rotating gear, such as a worm gear. A worm gear as a particular type of rotating gear may provide certain advantages, such as a self-locking feature as described herein. For ease of discussion gear 68 is described herein as a worm gear, although the invention is not so limited and other rotating gears could be used.

The embodiments of FIGS. 2 and 3 may include an upper housing 75 which may be mounted on an upper side 67 of the base 62. Bore holes 302 and 304 are provided throughout the base 62 and upper housing (one such hole is shown in FIG. 3) to receive an upwardly inserting bolt or screw to removeably attach upper housing 75 to base 62. The upper housing 75 and the base 62 may together define an interior cavity 67 within which the worm drive 64 may be substantially completely enclosed. Enclosing the worm drive 64 within the cavity 77 allows the possibility of lubricating the worm drive with grease or other suitable lubricant, and sealing off the interior cavity 77 at least sufficiently to prevent significant leakage of the lubricant. By substantially completely enclosing the interior cavity 77, the worm drive 64 may also be protected from sand, dirt, seawater, rain or other contaminants, as well as from UV radiation which might otherwise be damaging if any plastic or rubber materials were used within the cavity.

The worm 66 and worm gear 68 of the self-locking worm drive 64 are disposed in driving engagement with one another. The worm 66 may be rotatable about a first rotational axis 80 in response to rotation of the driving device 70 and the worm gear 68 may be rotatable about a second rotational axis 81 in response to rotation of the worm 66. The first rotational axis 80 and the second rotational axis 81 may be oriented transverse to one another. As used herein and in the claims, the term “self-locking” as used in reference to a worm drive refers to a worm drive which has a worm in driving engagement with a worm gear and in which rotation of the worm causes rotation of the worm gear but in which, rotation of the worm gear does not cause rotation of the worm, irrespective of whether or not rotation of the worm is not prevented or significantly resisted by any forces other than those resulting from the interaction between the worm gear and the worm.

In certain embodiments, including those illustrated in FIGS. 2 and 3, the worm may be rotatably mounted along first rotational axis 80 by having its upper end 83 journalled within a cylindrical pocket 84 formed in an interior wall of upper housing 75 and having a lower end 86 mounted in a bearing 87. Bearing 87 may be secured in position by being at least partially recessed within a pocket 89 formed in the base 62. Bearing 87 may be of any suitable type but in certain embodiments may preferably consist of, or may include, a needle bearing having a plurality of needles 90 disposed generally transverse to second rotational axis 81 to reduce friction and wear resulting from thrust loads along second rotational axis 81.

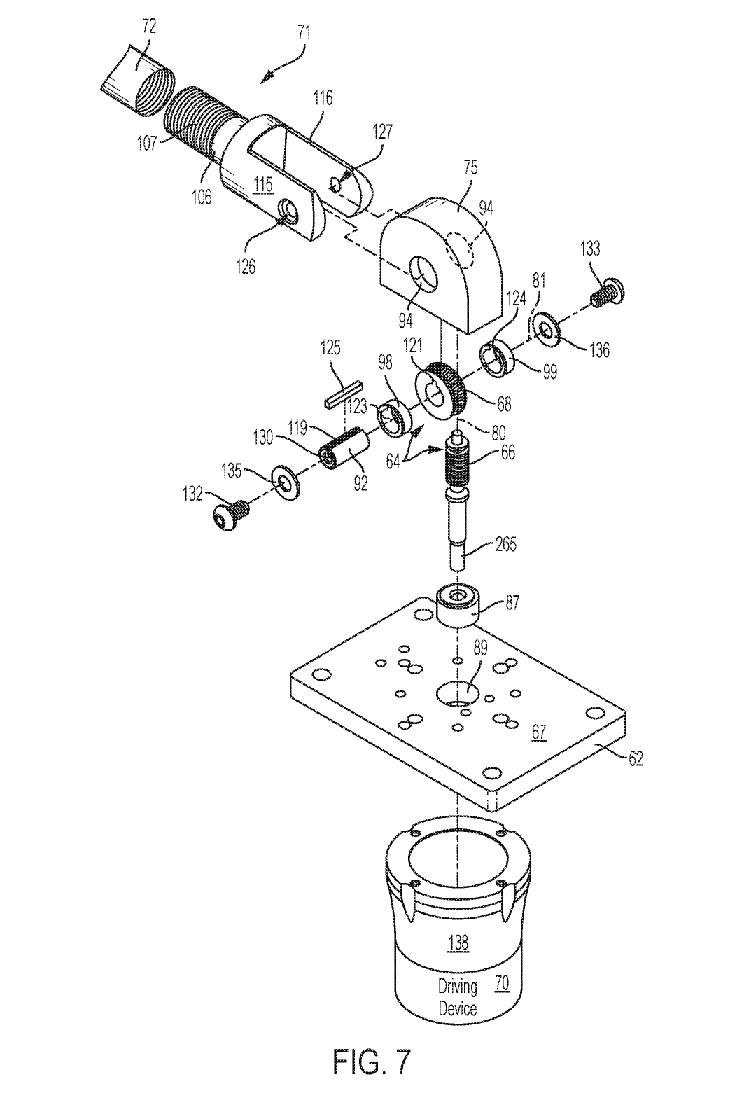

In certain embodiments, including those illustrated in FIGS. 2 and 3, the worm gear 68 may be mounted on a shaft 92 for rotation about the second rotational axis 81. Opposing end portions of the shaft 92 may be supported either directly in mutually opposed openings 94 formed in the upper housing 75 or within sleeves or other bearings 98, 99 mounted on, or in, such openings. As may be best understood from FIGS. 2, 3 and 7, worm gear 68 and bearings 98 and 99 may be mounted on a common shaft 92 with the bearings 98 and 99 spaced apart from one another along second rotational axis 81 and flanking the worm gear 68 from two sides and with bearings 68 and 69 being mounted to rotate in the openings 94 in the wall of housing so that substantially the entire mechanical load on the shaft 92, other than torque about second rotational axis 81, is transferred to the base 62 by way of the bearings 68, 69 and the upper housing 75. In embodiments where intermediate bearings, such as bearings and 68 and 69 are not used, the ends of shaft 92 may be journalled in the wall of upper housing 75 itself. In such cases, substantially the entire mechanical load on the shaft 92, other than torque about second axis 81, may be transferred to the base 62 directly by the upper housing 75.

Antenna support member 71, and/or the remainder of apparatus 60 in its entirety may, if desired, be provided in a form to which an antenna 72 is non-detachably attached. Alternatively, antenna support member 71, which may include any suitable structure to which an antenna 72 may be attached, either detachably or substantially permanently to antenna mount 60. Such a structure may be of a type appropriate for securement of whichever particular configuration of antenna with which apparatus may be used. In certain embodiments, such a structure may take the form of a detachable coupling such as a bayonet style coupling (not shown) or a stub 106 provided with external threads 107 such as for example those which may mate with female threads as commonly provided on certain types of commercially available marine two-way communications radio antennas.

Due to factors such as, for example, the actuation of antenna mount apparatus 60 itself, the weight of antenna 73, wind drag on antenna 73, impacts of antenna 73 with waves or objects, and/or inertial forces induced by normal motion of the marine vessel or buffeting of the marine vessel by wind or waves, antenna support member 71 may potentially become subject to significant forces and/or torques, including without limitation torque, about the longitudinal axis 110 of antenna support member. As a significant aid in reducing stress and strain due forces and/or torques and transferring the associated mechanical loading to base 62 in an improved manner, in certain embodiments, antenna support member 71 may include a bifurcated portion 113 which may include a pair of mutually spaced arms 115 and 116 which may straddle the upper housing 75 and rotationally couple the antenna support member 71 to the worm gear 68. Doing so permits such forces and/or torques to be transferred to the base by way of a path which includes portions of the upper housing 75 located on opposite sides of interior cavity 77 and which are separated from one another in the direction of second rotational axis 81. Providing substantial spacing between the arms 115, 116 of the bifurcated portion 113 of antenna support member 71 is of significant benefit, for among other things, increasing the ability of apparatus 60 to resist breakage or permanent deformation as result of torques about the longitudinal axis 110 of support member 71 which may be encountered due to external forces acting on antenna and/or antenna mount apparatus 60 itself.

Rotational coupling of the antenna support member 71 to the worm gear 68 may be implemented by, for example, providing shaft 92 with a keyway 119 which may be angularly aligned with corresponding keyways 121, 123, 124, 126, 127 present in worm gear 68, bearings 98 and 99, and arms 115 and 116 respectively and by securing shaft 92, worm gear 68, bearings 98 and 99, and arms 115 and 116 against rotation relative to one another with a key 125 which is received in each of the aforementioned keyways. Antenna support member 71 may be further secured to shaft 92 by providing shaft 92 with internal threads 130 which may receive fasteners, such as screws 132 and 135, which may pass through openings in arms 115 and 116 respectively by way of respective washers 135, 136. In certain embodiments, relatively large diameter washers (not shown) may be interposed between the inside face of each arm and the exterior of housing to prevent direct rubbing of the arms against the housing. Such washers may be of any suitable material and may consist of, or include, an metal or metal alloy such as brass or bronze, preferably one of galvanic compatibility with adjacent materials. Alternatively, such washers may consist of, or include, a synthetic material having relatively high lubricity such as for, example, materials available under the trade names Nylon®, Delrin® and Teflon®.

As noted above, marine antenna mount apparatus 60 may include a rotatable driving device 70 for supplying motive power to the worm drive 64 by supplying torque to worm 66 as required to effect positioning and repositioning of antenna 72 along its arc of travel. A gear train (not shown) may optionally be, but need not be, operably interposed between the rotatable driving device 70 and the worm 66 of the worm drive 64. Certain embodiments of apparatus 60 may also include, but need not necessarily include, a lower hosing secured to a underside of base. In embodiments where a lower housing is included, the lower housing may be used to house and/or support rotatable driving device as well as any moving parts which may be interposed operably between the rotatable driving device and the worm drive.

In certain embodiments, such as the embodiment of FIG. 3, the rotatable driving device 70 may comprise an electric motor 139. Electric motor 139 may include an output shaft 144 which may be rotationally coupled to worm 66 for supplying motive power to worm drive 64. Optionally, a gear train (not shown) may be operably interposed between motor 139 and worm 66 for purposes of providing intermediate rotational speed reduction and torque multiplication, if necessary or desired. Electric motor 139 may be of any suitable type, whether energizable by direct current (D. C.) or alternating current (A. C.) as may be available from any suitable source electrical energy available on a marine vessel. Electric motor 139 may be coupled to such energy source by way of a switch, relay, or other device a type suitable to enable a user to selectively energizing the motor 139 whenever desired and in a desired direction of rotation. If an electric motor 139 is used as a rotatable driving device 71, the interior 200 of lower housing 138 may be of a size suitable for enclosing motor 139 partially or completely inside lower housing 138.

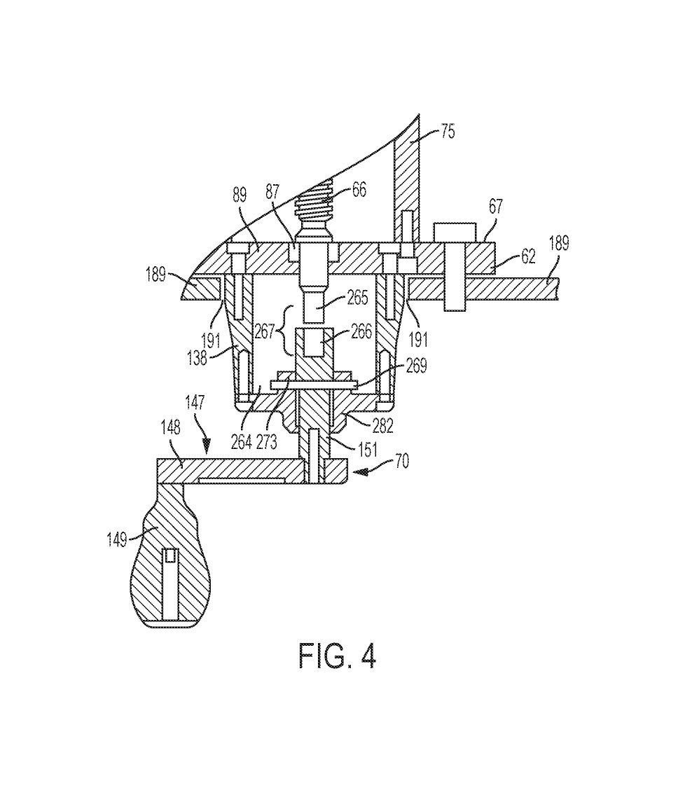

In manually powered embodiments, such as those shown in FIGS. 2 and 4, rotatable driving device 70 may comprise a manual hand crank 147. Manual hand crank 147 may include a crank arm 148. Manual hand crank 147 may also include a knob 149 which may be freely rotatably attached to one end of a crank arm 148. The other end of crank arm 148 may be rotatably driveably coupled to the worm, either directly, or by way of an output shaft 151. The knob 149 may be attached to the crank arm 148 to enable a user to easily grasp and operate manual hand crank 147.

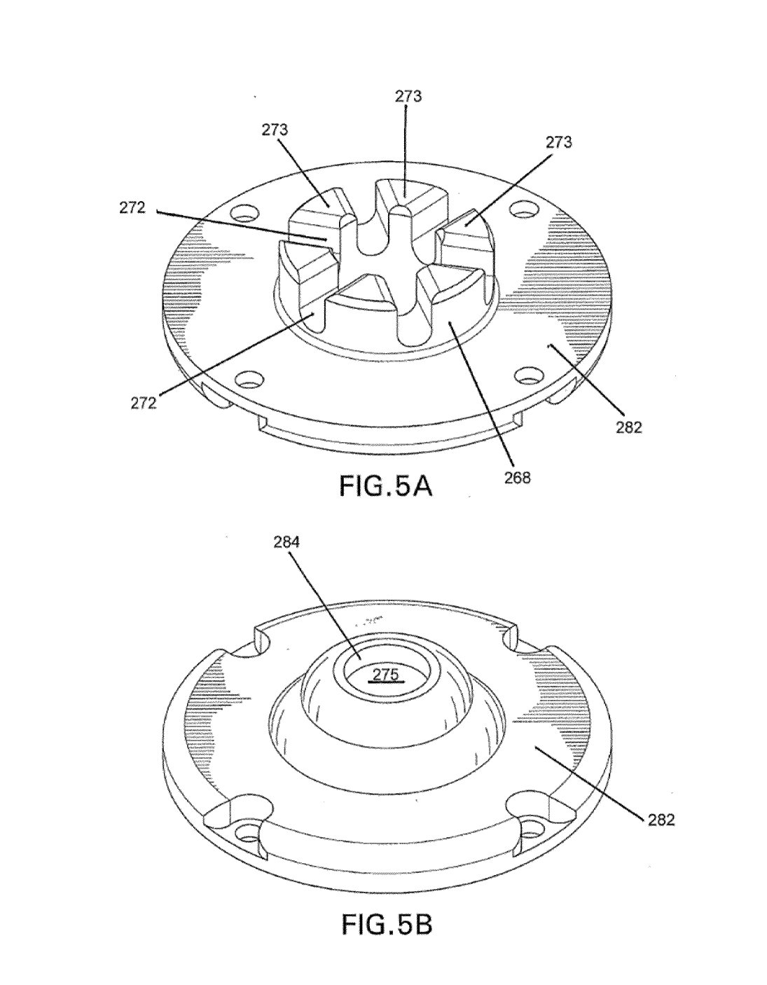

Referring additionally now to FIGS. 4, 5A and 5B, manually powered embodiments may optionally include a latch assembly 264 operably interposed between the rotatable driving device 9 and the worm drive 64. The latch assembly 264 may include at least two mutually engageable members 268, 269 which may have complementary-shaped mating surfaces. A first one of the latch members may comprise, for example, a pin 269. Pin 269 may extend from, or past completely or partially through, the output shaft 13 of the rotatable driving device and may extend a distance radially outward, such as in a direction generally orthogonal to the first rotational axis 80.

The second mutually engageable member of latch assembly 264 may suitably take the form of a boss 268 which may include at least one recess and preferably includes a plurality of such recesses 272 of suitable shape, dimension and location as to be able to receive the radially projecting portions of pin 269 when pin 269 is suitably angularly aligned therewith. Preferably, between recesses 272, boss 268 includes one or more projections which have surfaces which slope toward at least one adjoining recess 272 to guide pin 269 smoothly into engagement with a recess 272. Boss 268, including its one or more projections 273, is preferably axially centered on axis 10 and has a central opening 275 through which the output shaft 13 passes. Boss 268 can be mounted to, or formed integrally with, a plate 282 which can be secured to cap the lower end of lower housing 138. To mount the shaft 13 for smooth rotation as well as smooth axial translation, at least a portion of the peripheral wall of opening 275 may be fitted with a suitable bushing 284 which may be formed of a tough low-friction material such as brass or bronze, preferably one of galvanic compatibility with adjacent materials. Alternatively, bushing 284 washers may consist of, or include, a synthetic material such as for, example, a material available under the trade names Nylon®, Delrin® or Teflon®.

As shown in FIG. 4, the upper end of shaft 13 includes a recess 266 which, together with a drive tab 265 extending from a lower end of worm 66, forms a slip coupling 267. Drive tab 265 ends in an irregular shape (e.g., oval, hexagonal, square, etc.) and recess 266 has a mating shape such that rotation of shaft 151 will rotatably drive the worm 66 when drive tab 265 is received at least partially inside recess 266.

Due to gravity, drive tab 265 and recess 266 are not normally so engaged. However, when a user pushes crank 147 such that shaft 151 moves a sufficient distance in an upward direction, latch assembly 264 will disengage by forcing pin 269 out of recesses 272 and in the same motion, will cause drive tab 266 to be received in recess 266 and thus allow worm 66 to rotate about first rotational axis 80. Pin 269 must be maintained rotatably clear of boss 268 while shaft 151 being rotatably driven. Otherwise, engagement of pin 269 will lock the manual hand crank 147 against rotation.

When engaged, locking action of latch assembly 264 resists rotation which might otherwise occur as the result of torque applied from either side of latch assembly 264, including not only torque which might be applied intentionally via by the rotatable driving device 70 but also torque which, if self-locking worm drive 64 were to fail, might otherwise be transmitted back through the apparatus 60 due to the weight of antenna 72, and/or as a result of wind drag, impact of antenna 72 with waves or objects, and on inertial forces due for example to buffeting of the marine vessel by waves.

In use, latch assembly 264 will ordinarily be forcibly biased by gravity in favor of mutual engagement of pin 269 in recesses 267. For example, the combined weight of shaft 151, pin 269 and rotatable driving device 147 may all act in the direction of first rotational axis 80 and generate sufficient bias forces 286 to maintain pin 269 and boss 268 in rotatably locked engagement unless such force is counteracted by deliberate action of a user. If desired, one or more springs (not shown) can be provided to augment the gravitational of bias force acting on manual hand crank 147.

It is to be appreciated that in manually operated embodiments the provision of a latch assembly 264 may be particularly advantageous. A user will ordinarily be able to operate the latch assembly and rotatable drive mechanism with only one and the same hand. In addition to allowing one-handed operation, the latch assembly operates automatically in a fail-safe manner since there is no need for a user to remember or to perform a separate operation in order to engage the latch assembly.

Antenna mount apparatus 60 maybe mounted to a structure 189 of a marine vessel such as, for example, atop the roof of a pilot house, atop a T-top, atop a cabin or elsewhere. An opening 191, may be provided in the structure 189 of the marine vessel to permit its driving device to be operably accessed from below. For example, as shown in FIG. 4 apparatus 60 may be mounted such that its lower housing 138 may project at least partially into or through such opening 19 to enable a user actuate the driving device 70 below.

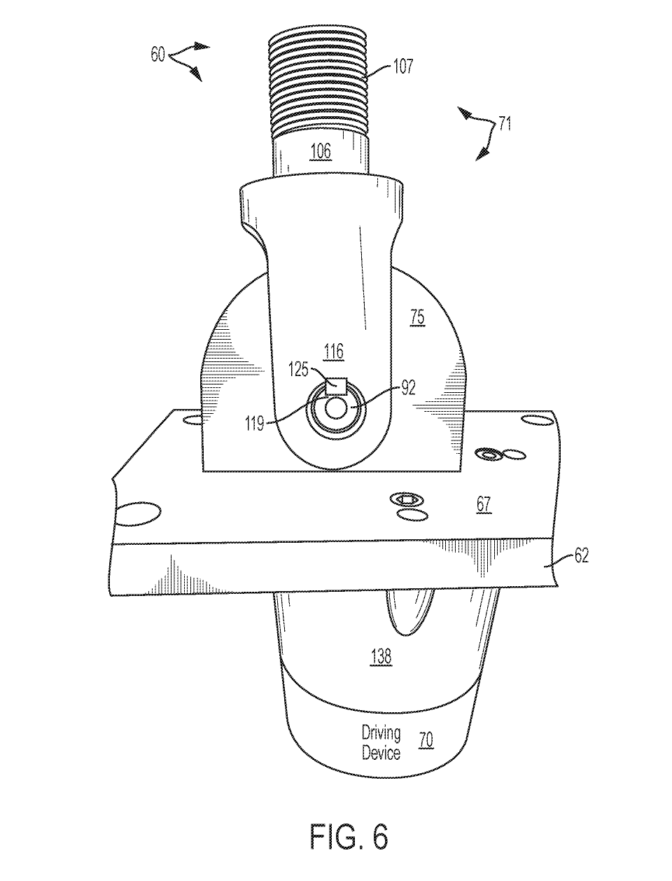

In operation, actuating rotatable driving device 70 to cause worm 66 to rotate about axis 80 in a clockwise direction will cause antenna support member 71 to pivot about second rotational axis 81 in a first angular direction along an arc of travel 278. Ceasing the rotation of rotatable driving device 70 at any time will cause antenna support member 71 to stop and hold antenna support member 71 securely in place, at any substantially infinitely variably selected angular position along arc of travel 278. For example, FIG. 6 shows antenna support member 71 stopped at an arbitrary position within the arc of travel 278. (Note that in FIG. 5 screw 133 and washer 136 are not shown attached in order to better show key 125, keyway 119 and shaft 92′).

Conversely, actuating rotatable device 70 to cause worm 66 to rotate about first rotational axis 80 in a counter-clockwise direction will cause worm gear 68 to pivot antenna support member 71 about second rotational axis in a second angular direction, opposite the aforementioned first angular direction, along arc of travel 278.

Irrespective of the angular position of antenna support member 71, the braking action of self-locking worm drive 64 will prevent movement of antenna support member 71 in response to externally applied forces which may act on the antenna support member, and such angular position will be maintained when rotatable driving device is not activated, regardless of whether a latch assembly 264, if one is present, is engaged or not. To assure worm drive 66 will be self-locking, the coefficient of friction between the worm 66 and the worm gear 68 may be less than the product of: (i) the cosine of the pressure angle of the worm drive and (ii) the helix angle of worm 66.

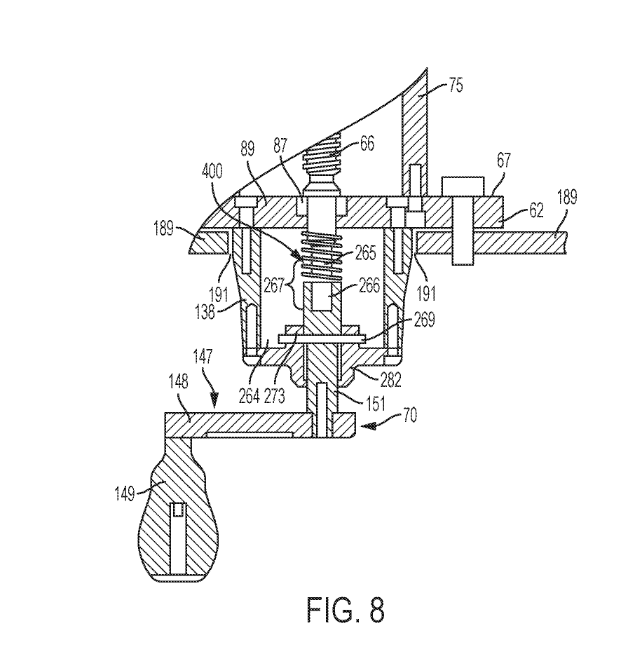

Referring now to FIG. 8, another embodiment is shown. The embodiment is identical to that discussed with respect to FIG. 4, except that spring 400 is shown for biasing output shaft 151 away from drive tab 265.

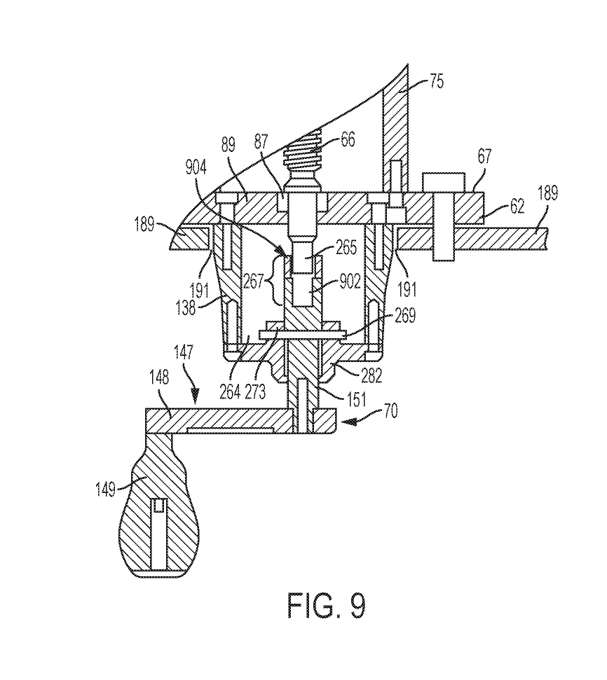

Referring now to FIG. 9, another embodiment is shown. The embodiment is identical to that discussed with respect to FIG. 4, except that drive shaft 151 extends upwards to overlap with drive tab 265 and define a tiered upper recess 902 and lower recess 904. Lower recess 904 corresponds to lower recess 266 in the embodiment of FIG. 4, and has an irregular mating shape to mate with the irregular shape of drive tab 265. Upper recess 902 is larger/wider than lower recess 904, such that drive tab 265 rotates freely within upper recess 902 without any driving engagement. Relative to the embodiment of FIG. 4, this non-engaging overlap assists in ensuring that drive shaft 151 mates with drive tab 265. The embodiment otherwise operates in the same manner as described in FIG. 4 and is not further described herein. A spring (not shown) could be added similar as shown in FIG. 8 to bias drive shaft 151 away from drive tab 265.

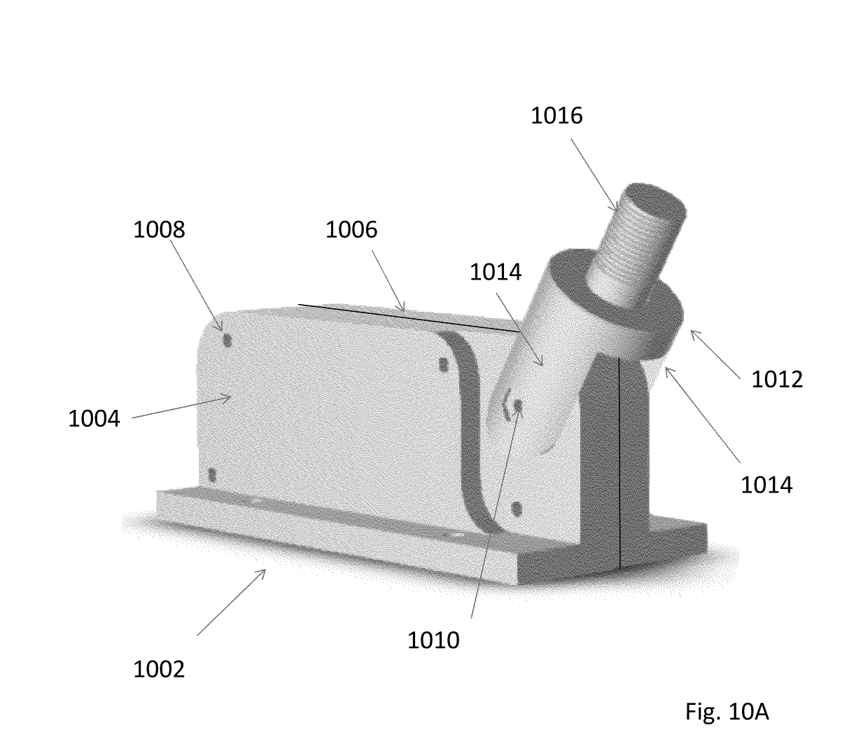

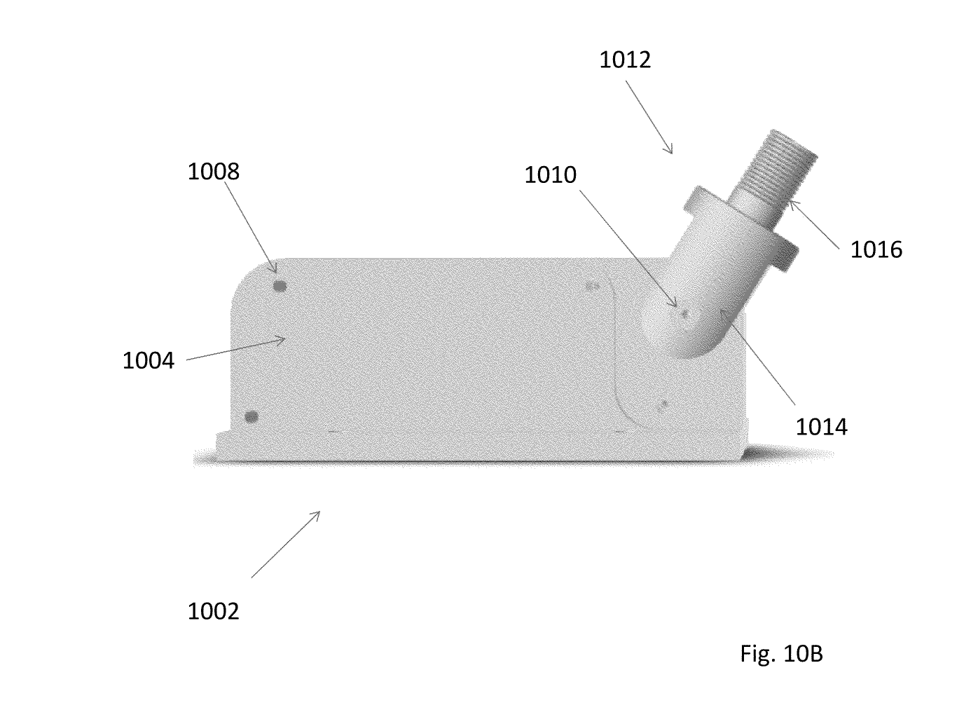

Referring now to FIGS. 10A and 10B, another embodiment of the invention is shown. A mount 1002 includes two half shells 1004 and 1006 which are removeably fastened together through fasteners (not shown) via holes 1008. A shaft 1010 extends through the half shells 1004 and 1006 to engage arms 1014 of one end of an antenna support member 1012. The other end of antenna support member 1012 includes a cylindrical stub 1016 having external threads by way of which an antenna (not shown) can be removably secured to mount 1002. A plurality of holes 1018 allow mount 1002 to be secured to above a structure (e.g., structure 189 of a marine vessel as shown in FIG. 4) using fasteners, although holes 1018 may extend from beneath and only partially though the mount 1002 so there is no exposure of the holes or fasteners from above to the external environment.

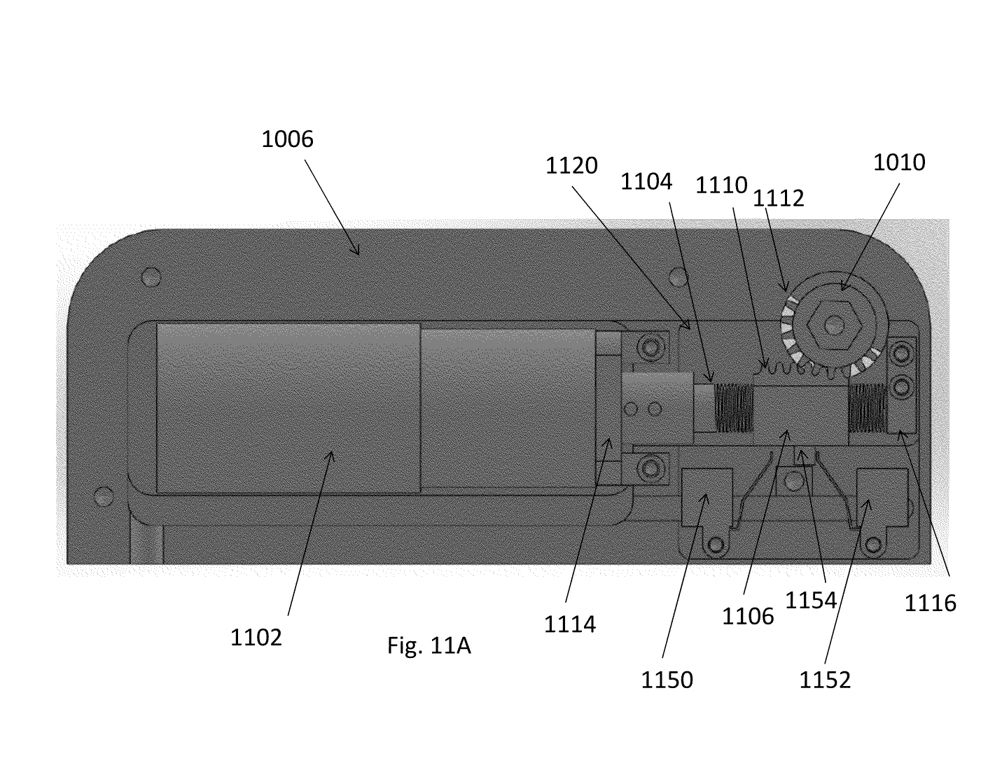

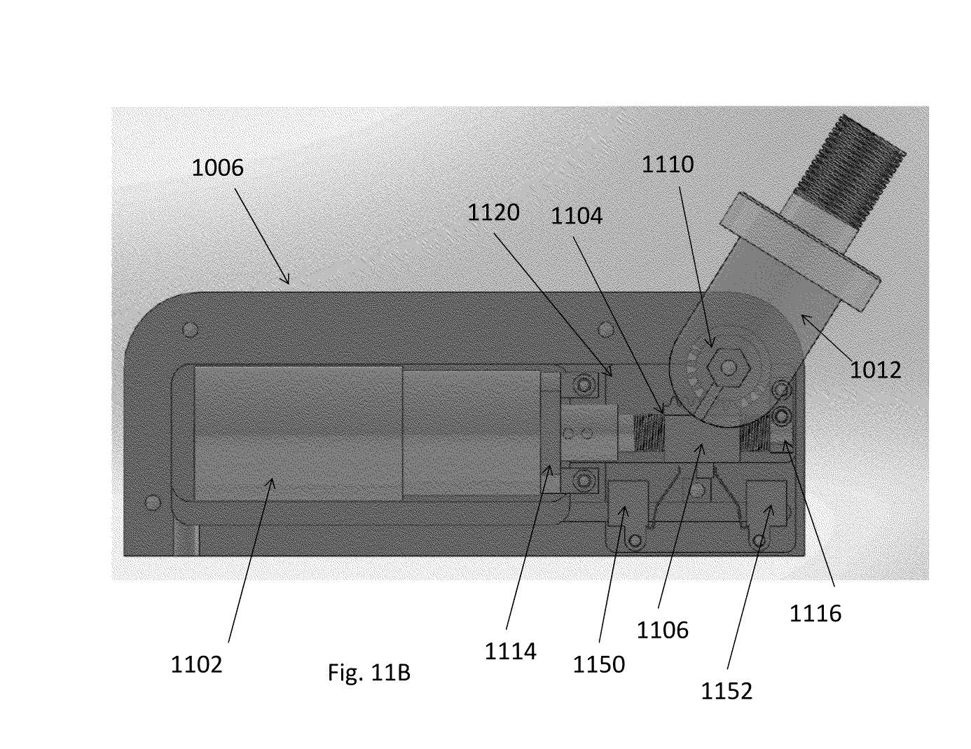

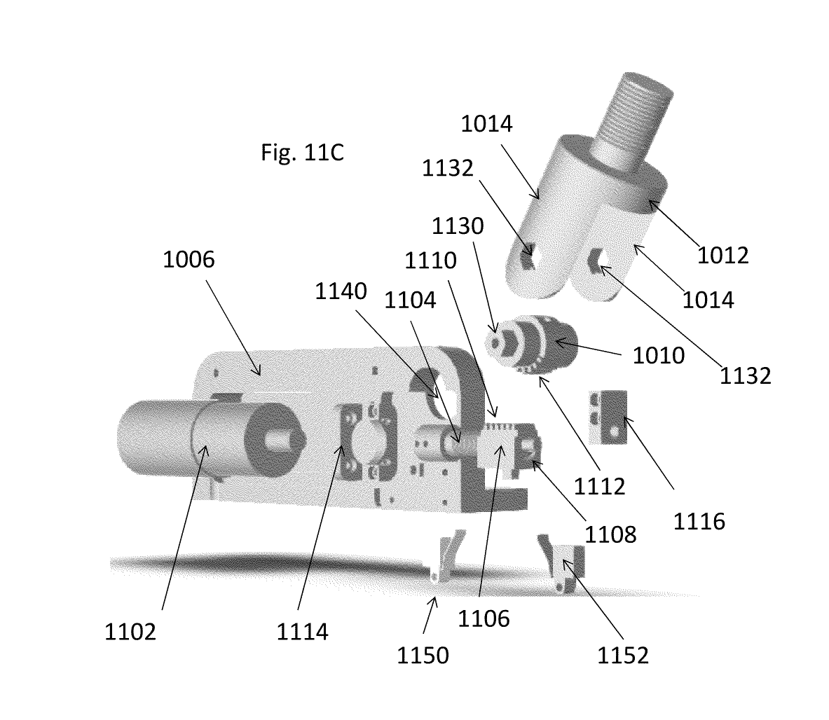

Referring now to FIG. 11A-11C, the interior drive components of the mount 1002 are shown via removal of half shell 1004, and further in FIG. 11B by the removal of antenna support member 1012. Interiors of Half shells 1004 and 1106 define a cavity 1120 in which the drive components are enclosed. Enclosing the drive components with cavity 1120 protects the drive components from sand, dirt, seawater, rain or other contaminants, as well as from UV radiation which might otherwise be damaging if any plastic or rubber materials were used within the cavity. Either shell 1004 or 1006 can be removed to all allows access to the interior drive components for repair or maintenance.

The drive components include an electric motor 1102 that rotates a longitudinally extending (front to back) worm 1104 (e.g., a threaded shaft). A block 1106 having a threaded bore hole 1108 is mounted on worm 1104. A side of block 1106 is supported by the interior wall of cavity 1120. A rack gear 1110 is attached to the top of block 1106. Rotatable shaft 1010 is mounted in lateral holes 1140 in half shells 1004 and 1006 perpendicular to worm 1104. At least a portion of rotatable shaft 1110 has gear teeth to define a (partially) rotating gear 1112 that engages rack gear 1110. The teeth of rotating gear 1112 may define a worm gear, a spur gear, or other type of rotating gear.

Front and rear supports 1114 and 1116 support motor 1102 and worm 1104. The ends of shaft 1110 have irregular shaped heads 1130, which may by way of non-limiting example be hexagonal heads. Arms 1014 of antenna support member 1012 have matching recesses 1132 to engage heads 1130 of shaft 1010.

Rotation of motor 1102 rotates worm 1104, which in turn moves threaded block 1106 forward or backward along mount 1002 (the direction being particular to the direction of motor rotation and the direction of the worm). Corresponding movement of rack gear 1110 on block 1106 rotates the rotating gear 1112 portion of shaft 1010, which in turn rotates antenna support member 1012. Movement of block 1106 forward thus rotates the antenna support member (and any attached antenna) into a substantially vertical deployed position, while movement of block 1106 rearward rotates the antenna support member 1012 into a substantially horizontal retracted position.

The boundaries of rotation of shaft 1110 can be set electrically by relays 1150 and 1152 that electrically connect to motor 1102 and will disengage the power flow to motor 1102 when tripped. Relays 1150 and 1152 are disposed on each side of the pathway traversed by block 1106. When a portion of block 1106, such as projection 1154, depresses either relay 1150 or 1152, the relay trips and stops motor 1102. Relays 1150 and 1152 are physically positioned relative to the block 1106 to define the range of motion by which motor 1102 can rotate antenna support member 1012.

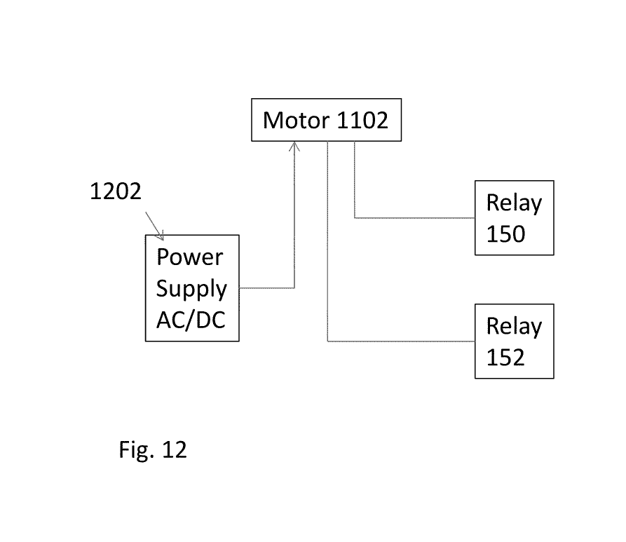

Referring now to FIG. 12, a schematic of electrical power for motor 1102 is shown. A power supply 1202 and relays 1150/1152 connect to motor 1102. The nature of the underlying circuit layout is well understood in the art and not further describe herein.

According to another embodiment of the invention, block 1106 and rack gear 1110 could be omitted, and rotating gear 1112 could directly engage with worm 1104. Block 1106 and rack gear 1110 may thus be considered an optional intervening gear assembly.

According to another embodiment of the invention, motor 1102 could be replaced with a hand crank similar to other embodiments herein with corresponding gear train to rotate worm 1104.

While the invention has been described with reference to the preferred embodiments, it should be understood by those skilled in the art that various changes may be made and equivalents substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An antenna mount apparatus for use on a marine vessel for supporting and angularly positioning an antenna, the apparatus comprising:
a housing configured to mount the apparatus to a support structure;
a bi-directionally rotatable driver mounted on the housing;
a worm configured to be rotatably driven by the driver about a first axis;
a rotatable member having gear teeth at least partially around a periphery of the rotatable member, and configured to be driven about a second axis perpendicular to the first axis in response to rotation of the worm; and
a rotatable antenna support member mounted on the rotatable member configured to support an antenna and to rotate in response to the rotatable member, the antenna support member being rotatable between a substantially horizontal position and a substantially vertical position.

2. The apparatus of claim 1, wherein the apparatus is self-locking, whereby the worm prevents rotation of the antenna support in response to the external forces applied to the antenna support, other than from actuation of the a bi-directionally rotatable driver.

3. The apparatus according of claim 1, wherein the rotatable driver comprises a manually powered hand crank.

4. The apparatus according to claim 3, wherein the hand crank is moveable between two vertical positions, the first position being higher than the second position, wherein in the first position the crank is coupled to the worm such that rotation of the crank drives the worm, and wherein in the second position the crank is decoupled from the worm.

5. The apparatus according to claim 4, wherein gravity biases the hand crank toward the second position.

6. The apparatus of claim 4, wherein a spring biases the hand crank toward the second position.

7. The apparatus of claim 4, wherein when the apparatus prevents the crank from rotating in the second position.

8. The apparatus of according to claim 1, wherein the driver comprises an electric motor.

9. The apparatus of claim 1, further comprising electrical relays configured along a path of the worm, the apparatus being configured to trip one of the relays and disable the motor if the motor over rotates the antenna support member.

10. The apparatus of claim 1, further comprising a threaded block mounted on the worm, a rack gear mounted on the block, the rack gear engages with the rotating gear, wherein rotation of the worm moves the block and rack gear to thereby rotate the rotating gear.

11. An antenna mount apparatus for use on a marine vessel for supporting and angularly positioning an antenna, the apparatus comprising:
a housing configured to mount the apparatus to a support structure;
hand crank mounted on the housing;
a worm configured to be rotatably driven by the crank about a first axis;
a worm gear coupled to and configured to be driven about a second axis perpendicular to the first axis in response to rotation of the worm; and
a rotatable antenna support member having lateral arms mounted on the worm gear, configured to support an antenna and to rotate in response to the rotatable member, the antenna support member being rotatable between a substantially horizontal retracted position and a substantially vertical deployed position;
wherein the apparatus is self-locking, whereby the worm prevents rotation of the worm gear as a result of external forces applied to the antenna support other than from actuation of the crank.

12. The apparatus according to claim 11, wherein the hand crank is moveable between first and second vertical positions, the first position being higher than the second position, wherein when in the first position the crank is coupled to the worm such that rotation of the crank drives the worm, and wherein when in the second position the crank is decoupled from the worm.

13. The apparatus according to claim 12, wherein gravity biases the hand crank toward the second position.

14. The apparatus of claim 12, wherein a spring biases the hand crank toward the second position.

15. The apparatus of claim 12, wherein when the apparatus prevents the crank from rotating in the second position.

16. The apparatus of claim 12, further comprising:
a plate with at least one groove mounted to the housing; and
a shaft coupled to the crank and having a pin;
wherein in the first position of the crank the pin is within one of the grooves such that engagement of the pin with the one of the grooves prevents rotation of the crank;
wherein in the second positon of the crank the pin is outside of the at least one groove such that the at least one groove does not interfere with the rotation of the crank.

17. The apparatus of claim 16, wherein the shaft extends through the plate.
